(19) United States
(12) Patent Application Publication
(10) Pub. No.: US 2010/0325591 A1
(43) Pub. Date: Dec. 23, 2010

(54) Generation and Placement Of Sub-Resolution Assist Features

(75) Inventors: George P. Lippincott, Lake Oswego, OR (US); Loran Friedrich, Portland, OR (US)

Correspondence Address: MENTOR GRAPHICS CORP.;PATENT GROUP, 8005 SW BOECKMAN ROAD, WILSONVILLE, OR, 97070-7777, US

(73) Assignee: Mentor Graphics Corporation

(21) Appl. No.: 12/821,065

(22) Filed: Jun. 22, 2010

Related U.S. Application Data
(60) Provisional application No. 61/219,284, filed on Jun. 22, 2009.

(51) Int. Cl. G06F 17/50

(52) U.S. Cl. 716/54; 716/55

(57) ABSTRACT

Sub-resolution assist features (SRAFs) are placed in a template form and in series adjacent to main features in a layout design. After each SRAF template is placed, a clean-up process is conducted according to clean-up rules if necessary. Both SRAF templates and clean-up rules may be derived by using a model-based method or an optimization approach. Methods according to various embodiments of the invention may be used to place SRAFs near some two-dimensional main features such as contact features.

### RELATED APPLICATIONS

This application claims priority to U.S. Provisional Patent Application No. 61/219,284, entitled “Generation Of Assist Features For Microdevice Layout Designs,” filed on Jun. 22, 2009, and naming George P. Lippincott and Loran Friedrich as inventors, which application is incorporated entirely herein by reference.

### FIELD OF THE INVENTION

The present invention is directed to resolution enhancement techniques for photolithography. Various aspects of the invention may be particularly useful for the generation and placement of sub-resolution assist features.

### BACKGROUND OF THE INVENTION

Electronic circuits, such as integrated circuits (ICs), are used in a variety of products, from automobiles to microwaves to personal computers. Designing and fabricating IC devices typically involves many steps, sometimes referred to as the “design flow.” The particular steps of a design flow often are dependent upon the type of the circuit, its complexity, the design team, and the circuit fabricator or foundry that will manufacture the circuit. Typically, software and hardware “tools” verify the design at various stages of the design flow by running software simulators and/or hardware emulators. These steps aid in the discovery of errors in the design, and allow the designers and engineers to correct or otherwise improve the design.

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. The relationships between the electronic devices are then analyzed, to confirm that the circuit described by the device design will correctly perform the desired functions. This analysis is sometimes referred to as “formal verification.” Additionally, preliminary timing estimates for portions of the circuit are often made at this stage, using an assumed characteristic speed for each device, and incorporated into the verification process.

Once the components and their interconnections are established, the design is again transformed, this time into a physical design that describes specific geometric elements. This type of design often is referred to as a “layout” design. The geometric elements, which typically are polygons, define the shapes that will be created in various layers of material to manufacture the circuit. Typically, a designer will select groups of geometric elements representing IC components (e.g., contacts, channels, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

Circuit layout descriptions can be provided in many different formats. The Graphic Data System II (GDSII) format is a popular format for transferring and archiving two-dimensional (2D) graphical circuit layout data. Among other features, it contains a hierarchy of structures, each structure containing layout elements (e.g., polygons, paths or poly-lines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (SEMI). These various industry formats are used to define the geometrical information in layout designs that are employed to manufacture integrated circuits. Once the design is finalized, the layout portion of the design can be used by fabrication tools to manufacture the circuit using a photolithographic process.

There are many different fabrication processes for manufacturing a circuit, but most processes include a series of steps that deposit layers of different materials on a substrate, expose specific portions of each layer to radiation, and then etch the exposed (or non-exposed) portions of the layer away. For example, a simple semiconductor device component could be manufactured by the following steps. First, a positive type epitaxial layer is grown on a silicon substrate through chemical vapor deposition. Next, a nitride layer is deposited over the epitaxial layer. Then specific areas of the nitride layer are exposed to radiation, and the exposed areas are etched away, leaving behind exposed areas on the epitaxial layer, (i.e., areas no longer covered by the nitride layer). The exposed areas then are subjected to a diffusion or ion implantation process, causing dopants, for example phosphorus, to enter the exposed epitaxial layer and form charged wells. This process of depositing layers of material on the substrate or subsequent material layers, and then exposing specific patterns to radiation, etching, and dopants or other diffusion materials, is repeated a number of times, allowing the different physical layers of the circuit to be manufactured.

Each time that a layer of material is exposed to radiation, a mask must be created to expose only the desired areas to the radiation, and to protect the other areas from exposure. The mask is created from circuit layout data. That is, the geometric elements described in a layout design define the relative locations or areas of the circuit that will be exposed to radiation through the mask. A mask or reticle writing tool is used to create the mask based upon the layout design, after which the mask can be used in a photolithographic process.

As designers and manufacturers continue to increase the number of circuit components in a given area and/or shrink the size of circuit components, the shapes reproduced on the substrate (and thus the shapes in the mask) become smaller and are placed closer together. This reduction in feature size increases the difficulty of faithfully reproducing the image intended by the layout design onto the substrate. Adding to the difficulty associated with increasingly smaller feature size is the diffractive effects of light. These effects often result in defects where the intended image is not accurately “printed” onto the substrate during the photolithographic process, creating flaws in the manufactured device. One type of flaw is proximity effects. Proximity effects are the variations in the linewidth of a feature (or a shape for a 2D pattern) as a function of the proximity of other nearby features. The simplest example of a proximity effect is the difference in printed linewidth between an isolated line and a line in a dense array of equal lines and spaces.

To address the problem, one or more resolution enhancement techniques are often employed to improve the resolution of the image that the mask forms on the substrate during the photolithographic process. Examples of various resolution enhancement techniques are discussed in “Resolution Enhancement Technology: The Past, the Present, and Extensions for the Future,” Frank M. Schellenberg, Optical Microlithography XVII, edited by Bruce W. Smith, Proceedings of SPIE Vol. 5377, which article is incorporated entirely herein by reference. One of these techniques, “optical proximity correction” or “optical process correction” (OPC), adjusts the amplitude of the light transmitted through a lithographic mask by modifying the layout design data employed to create the mask. For example, edges in the layout design may be adjusted to make certain portions of the geometric elements larger or smaller, in accordance with how much additional light exposure (or lack of exposure) is desired at certain points on the substrate. When these adjustments are appropriately calibrated, overall pattern fidelity is greatly improved, reducing proximity effects. This is often referred to as the conventional OPC approach.

Another way to implement the OPC technique involves adding geometric elements (sub-resolution assist features, or SRAFs) in the layout design. This approach is sometimes simply referred to as SRAF. While the conventional OPC approach certainly corrects many proximity effects, it does not address one proximity effect—variations in focus condition. The variations in focus condition become significant when an off-axis illumination scheme (one of the three major resolution enhancement technologies) is optimized for greatest depth of focus of densely placed features. SRAFs are designed to reduce the difference by making a relatively isolated main feature behave lithographically more like a densely-placed main feature. For example, scattering bars, a common type of SRAFs, may be placed adjacent to relatively isolated lines (main features), allowing the isolated lines to diffract light like dense lines. Here, a main feature is referred to as a feature that is intended to print.

An SRAF, as the name implies, is a sub-resolution feature that is not meant to print. It must be carefully adjusted in size and position so that it never prints over the needed process window. This determines the most important trade-off in SRAF generation and placement: making the assist features as large and dense as possible in order to create a more dense-like mask pattern, but not so large or dense that they print. Just like the conventional OPC approach, there are rule-based SRAF and model-based SRAF methods. The rule-based SRAF methods are quite common, but have difficulty with 2D placement. For example, there is a problem of what to do with contact or via features. The model-based SRAF methods show promise for complex 2D geometries, but are difficult to implement. It is desirable to have SRAF methods that not only preserve the simplicity of the rule-based SRAF methods but also have a quality similar to the model-based SRAF methods.

### BRIEF SUMMARY OF THE INVENTION

Aspects of the invention relate to generation and placement of sub-resolution assist features (SRAFs). SRAF templates may be generated using a model-based method. For example, with some implementations of the invention, a model-based method first places SRAFs near a test pattern formed by one or more main features. SRAF templates then may be constructed based on the placed SRAFs. An optimization approach may also be used to generate SRAF templates. The optimization approach may start with SRAF templates generated by using conventional rule-based SRAFs, and then modify these SRAF templates by optimizing a process variation metric. The SRAF templates may be applied in series to main features identified in a layout design. These main features belong to the same type of features for which the SRAF templates are generated. A clean-up process may be performed according to various clean-up rules if conflicts arise after applying an SRAF template. The various clean-up rules may be derived with one or more of the following methods: a model-based method, an optimization approach, and user's empirical experience. Various embodiments of the invention may be implemented in combination with a conventional rule-based SRAF placement method.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 illustrates an example of an SRAF placement tool.

FIG. 4 illustrates a flowchart describing methods of placing SRAFs according to various embodiments of the invention.

FIG. 5 illustrates three SRAF templates for a square contact feature.

### DETAILED DESCRIPTION OF THE INVENTION

Various aspects of the present invention relate to generating and placing SRAFs. In the following description, numerous details are set forth for the purpose of explanation. However, one of ordinary skill in the art will realize that the invention may be practiced without the use of these specific details. In other instances, well-known features have not been described in details to avoid obscuring the present invention.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “generate” and “place” to describe the disclosed methods. Such terms are high-level abstractions of the actual operations that are performed. The actual operations that correspond to these terms will vary depending on the particular implementation and are readily discernible by one of ordinary skill in the art.

Also, as used herein, the term “design” is intended to encompass data describing an entire integrated circuit device. This term also is intended to encompass a smaller group of data describing one or more components of an entire device, however, such as a portion of an integrated circuit device. Still further, the term “design” also is intended to encompass data describing more than one microdevice, such as data to be used to form multiple microdevices on a single wafer.

### Operating Environment

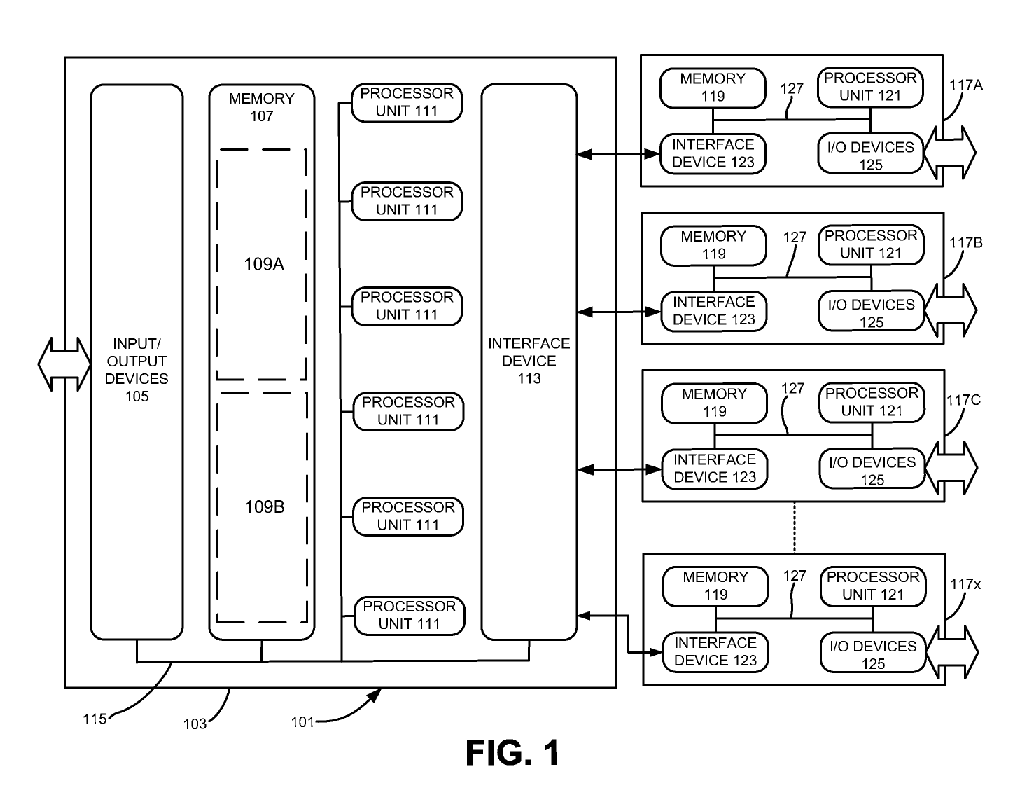

The execution of various electronic design automation processes may be implemented using computer-executable software instructions executed by one or more programmable computing devices. Because these examples of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or slave computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

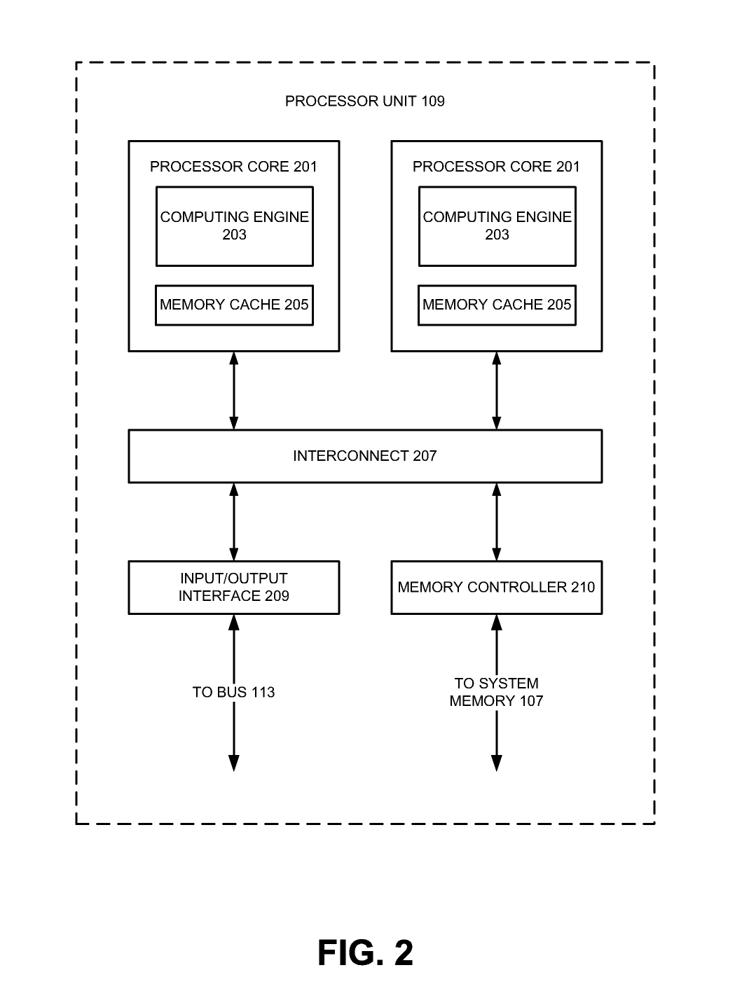

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the slave computers 117A, 1157, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the slave computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 117 may include a memory 119, a processor unit 121, an interface device 122, and, optionally, one more input/output devices 125 connected together by a system bus 127. As with the master computer 103, the optional input/output devices 125 for the slave computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the slave computers 117 to communicate with the master computer 103 over the communication interface.

In the illustrated example, the master computer 103 is a multi-processor unit computer with multiple processor units 111, while each slave computer 117 has a single processor unit 121. It should be noted, however, that alternate implementations of the invention may employ a master computer having single processor unit 111. Further, one or more of the slave computers 117 may have multiple processor units 121, depending upon their intended use, as previously discussed. Also, while only a single interface device 113 or 123 is illustrated for both the master computer 103 and the slave computers, it should be noted that, with alternate embodiments of the invention, either the computer 103, one or more of the slave computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the slave computers 117 may alternately or additions be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### SRAF Placement Tool

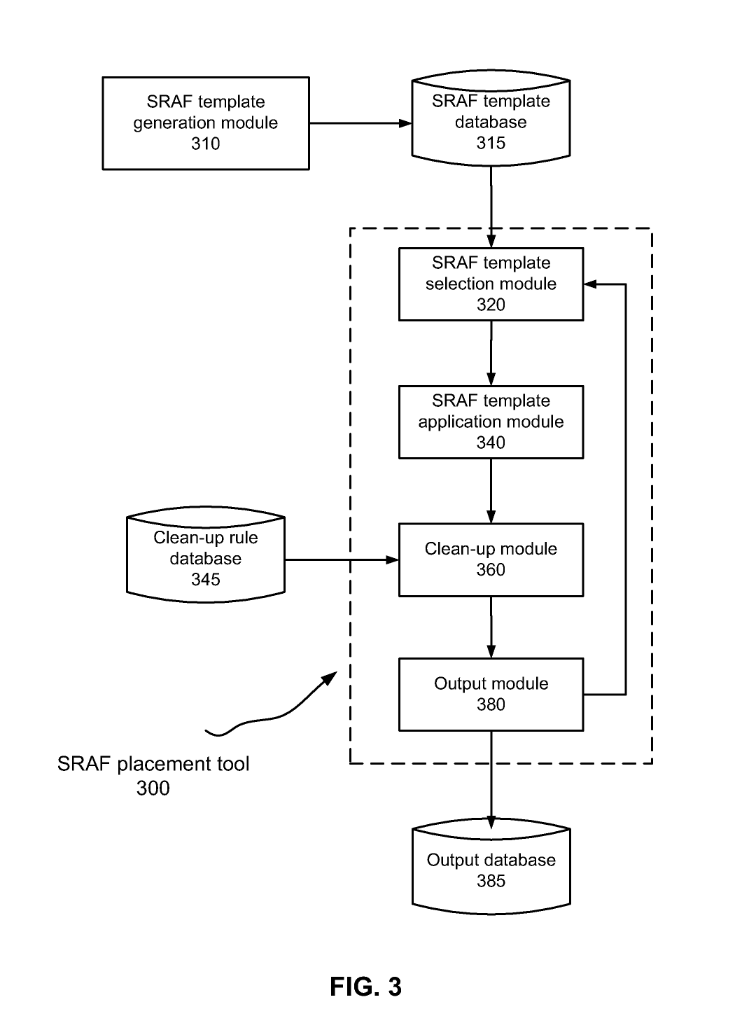

FIG. 3 illustrates an example of an SRAF placement tool 300 that may be implemented according to various embodiments of the invention. As seen in the figure, the SRAF placement tool 300 includes an SRAF template selection module 320, an SRAF template application module 340, a clean-up module 360 and an output module 380. As also shown in this figure, various implementations of the SRAF placement tool 300 may cooperate with (or incorporate, in whole or part) an SRAF template generation module 310, an SRAF template database 315, a clean-up rule database 345 and an output database 385.

As will be discussed in detail below, the SRAF placement tool 300 places SRAFs adjacent to main features of a layout design to compensate for proximity effects. The SRAFs to be placed are generated in the form of SRAF templates by the SRAF template generation module 310. An SRAF template defines the placement of one or more SRAFs near a single main feature such as a contact or via feature. The SRAF templates generated by the SRAF template generation module 310 are stored in the SRAF template database 315. The SRAF placement tool 300 receives a set of SRAF templates generated for a certain type of main feature and applies these SRAF templates in series to each main feature in a layout design that belongs to the certain type.

More specifically, the SRAF template selection module 320 in the tool 300 selects an SRAF template from a set of SRAF templates according to a predefined order or a user's instruction. The SRAF template application module 340 identifies main features in the layout design belonging to the particular type of main features for which the set of SRAF templates have been generated and applies the selected SRAF template to each of them. The SRAF template being applied may cause conflicts with either a main feature or an SRAF already placed, forming conflict regions. A conflict region is an area roughly defined by the SRAFs that generated a conflict. Based on predefined clean-up rules stored in the clean-up rule database 345, the clean-up module 360 adjusts SRAFs in the conflict regions to eliminate conflicts produced by the placement of the selected SRAF template. It should be obvious to a person having ordinary skill in the art that the predefined clean-up rules may be generated using a model based method, empirical experience, or other approaches. The output module 380 then decides whether more SRAFs are needed. A simple criterion is whether there are more SRAF templates left in the set that have not been applied. If the answer is yes, the above process will be repeated until the last one is placed. Different criteria may be applied. The SRAF pattern formed by the placed SRAF templates is then stored in the output database 385.

As previously noted, various embodiments of the invention may be embodied by a computing system, such as the computing system illustrated in FIG. 1 and FIG. 2. Accordingly, one or more components of each of the SRAF template generation module 310, the SRAF template selection module 320, the SRAF template application module 340, the clean-up module 360 and the output module 380 may be implemented using one or more processors in a computing system. It should be appreciated that, while these five modules are shown as separate units in FIG. 3, a single computer (or a single processor in a computing system) may be used to implement two or more of these modules at different times. Also, various examples of the invention may be embodied by software-executable instructions, stored on a computer-readable medium, for instructing a computing system to implement one or more components of each of the SRAF template selection module 320, the SRAF template application module 340, the clean-up module 360 and the output module 380. Further, while the SRAF template database 315, the clean-up rule database 345 and the output database 385 are shown as separate units in FIG. 3, a single computer accessible medium may be used to implement two or all three of these databases. Still further, each module may either be fully automated or allow a user to provide instructions for an operation.

### Generation and Placement of SRAF Templates

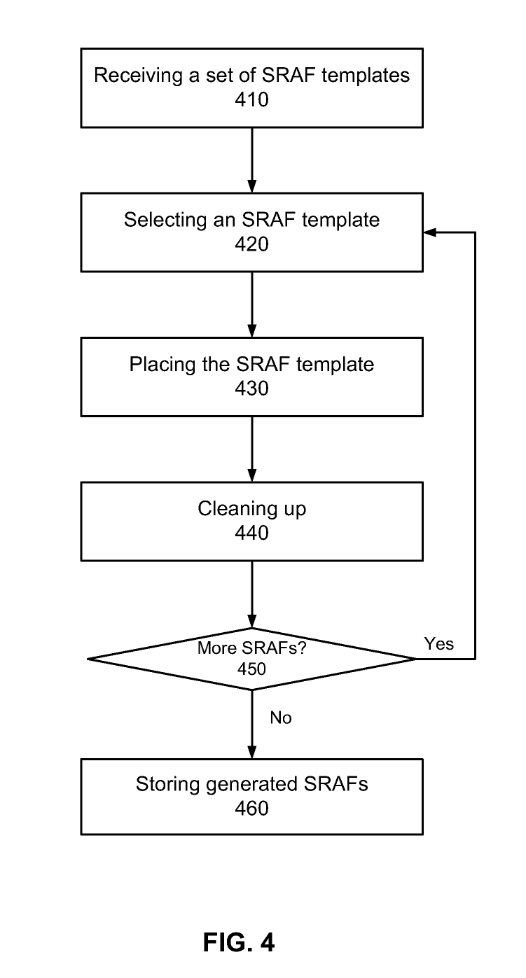

FIG. 4 illustrates a flowchart describing methods of placing SRAFs according to various embodiments of the invention. For purposes of explanation, various methods encompassed in FIG. 4 will be described with reference to the SRAF placement tool 300 shown in FIG. 3. It should be appreciated that the operations illustrated in FIG. 4 may be employed by implementations of a different SRAF placement tool, according to various embodiments of the invention. Likewise, it should be appreciated that the SRAF placement tool 300 shown in FIG. 3 may be used to perform methods according to various embodiments of the invention different from those encompassed by the flowchart of FIG. 4.

Also, it should be appreciated that various embodiments of the invention may be implemented by a system comprising one or more processors programmed to perform the operations described in FIG. 4. Still further, various embodiments of the invention may be implemented by processor-executable instructions, stored in a processor-readable medium, for causing one or more processors to perform the operations described in FIG. 4.

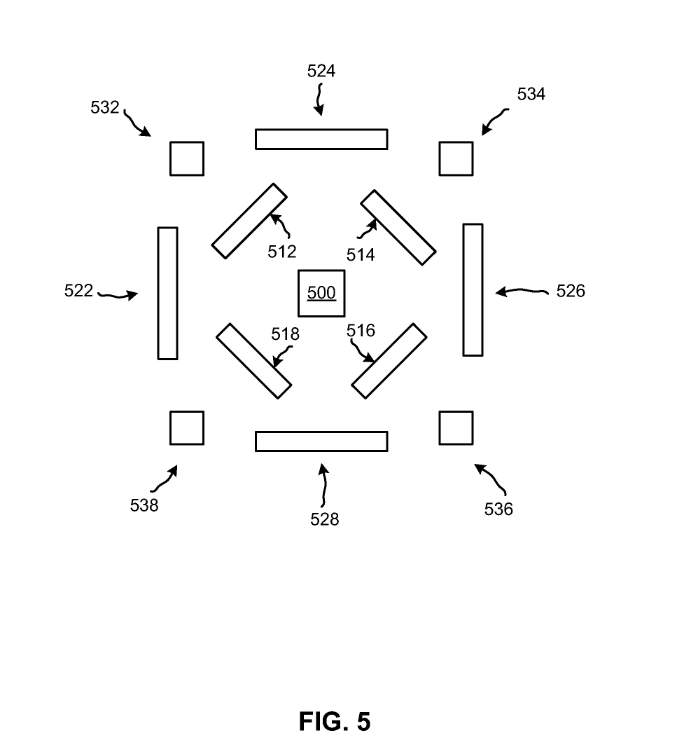

The flow illustrated in FIG. 4 starts with operation 410, receiving a set of SRAF templates by the SRAF placement tool 300. As mentioned before, an SRAF template is an arrangement of SRAFs around or near a main feature. FIG. 5 illustrates examples of three SRAF templates for a square contact feature 500. The SRAF template closest to the contact feature 500 consists of four 45 degree bar-shaped SRAFs, 512, 514, 516 and 518. This template is sometimes referred to as a primary template because SRAFs in this template may play a bigger role than others in compensating for the proximity effect. The other four bar-shaped SRAFs, 522, 524, 526 and 528, form the second SRAF template. The four square-shaped SRAFs 532, 534, 536 and 538 constitute the third SRAF template. It should be noted that these three templates are just examples. SRAF templates may be constructed in different ways and the contact feature 500 can have fewer or more SRAF templates. Also, SRAFs in a template do not always surround a main feature even though many SRAF templates show such configurations. Sometimes a single SRAF can form a SRAF template. In general, SRAF templates are dependent upon the optical configuration of the lithographic system. For example, asymmetric optical source configurations prefer asymmetrical SRAF templates. The shape and size of a main feature and its relationship with neighboring main features may also dictate the geometry and placement of SRAFs in an SRAF template. There are diverse approaches that can be used to construct SRAF templates.

With various implementations of the invention, the SRAF template generation module 310 may be configured to construct SRAF templates using a model based approach. Specifically, the SRAF template generation module 310 first employs a model based approach to generate SRAFs for a number of test patterns that represent possible configurations of main features in a layout design. Then, SRAF templates are extracted from the generated SRAFs in a way to retain the benefit of the model based approach as much as possible.

According to some embodiments of the invention, the SRAF template generation module 310 may start with an isolated main feature, e.g. a contact feature, as a test pattern. A model based tool, such as PIXBAR OPC in the Calibre family of software tools available from Mentor Graphics Corporation, Wilsonville, Oreg., is used to synthesize an optimized mask pattern for the isolated main feature. SRAFs with common shapes such as squares, bars and rings are then placed in the regions identified from the optimized mask pattern. Finally, these placed SRAFs are used to construct SRAF templates. Typically, an SRAF template consists of SRAFs having a certain shape and/or relationship with the main feature, as illustrated by the three SRAF templates in FIG. 5. It should be appreciated by a person having ordinary skill in the art that different SRAF templates may be constructed from the same optimized mask pattern.

More SRAF templates can be generated by adding another main feature to the existing isolated one and adjusting the distance between them. When the two main features move closer, some of the SRAFs in the SRAF templates for isolated main features if directly applied will become too close to each other or to a main feature. This results in conflicts because either one or more MRC (manufacturing rule check) rules are violated or some SRAFs will be printed. By comparing PIXBAR results for the pair of main features with the direct application of the SRAF templates for isolated main features, rules for dealing with conflicts may be derived. For example, a small and a full-sized SRAF may be placed at the geometric center of a conflict region in some cases. In some other cases, SRAFs from one type of templates may be placed in the conflict region formed by another type of templates. In still some other cases, a new type of SRAF templates may be generated to fill in a conflict region. The above process also provides applicable ranges for the SRAF templates and may be repeated by adding more main features to include interactions between multiple main features.

In various embodiments of the invention, some SRAF templates may be generated by focusing on the conflict regions only. For example, after two main features move closer and conflicts arise, all SRAFs outside the conflict regions may be removed. One or more new SRAFs are placed in or near the conflict regions either based on a model based solution or clean-up rules. From the one or more new SRAFs in or near the conflict regions, a new SRAF template may then be extracted.

Besides using a model based approach, the SRAF template generation module 310 may also generate SRAF templates through an optimization procedure. In some embodiments of the invention, the starting SRAF templates may be constructed based on a conventional rule-based approach or an empirical solution. These starting SRAF templates are then being modified algorithmically to optimize a process variation metric. For example, the final SRAF templates may be obtained by minimizing PV (process variation) bands or maximizing area ratios between the extreme processing conditions. Many existing tools may be used to derive the PV band or area ratio information, such as OPCVerify in the Calibre family of software tools available from Mentor Graphics Corporation, Wilsonville, Oreg.

The whole process of generating SRAF templates can be executed automatically by the SRAF template generation module 310: first converting irregular SRAFs derived by an model-based tool to SRAFs with regular shapes, then analyzing the location of these SRAFs relative to the main feature, and finally extracting SRAF templates. The process may also rely heavily on interactions with users. In some embodiments of the invention, users can guide the extracting operation with their empirical experience. In such cases, a graphic user interface may be adopted to facilitate the construction of SRAF templates.

Once a set of SRAF templates are generated for a specific type of main features and received by the SRAF placement tool 300, they are applied in series to the type of main features identified in a layout design. The operations 420 through 460 in FIG. 4 illustrated the steps of the process according to various embodiments of the invention. In operation 420, the SRAF template selection module 320 selects an SRAF template from the set of SRAF templates received by the SRAF placement tool 300. In many cases, SRAF features from one SRAF template have precedence over SRAF features from another template. For example, an SRAF template with SRAFs in close proximity to the main feature plays a more important role in compensating for proximity effects than another SRAF template with SRAFs placed further away from the main feature does. The former thus has a higher priority for placement than the latter with various implementations of the invention. This priority may be represented by a priority parameter to be associated with an SRAF template. The SRAF template selection module 320 may conduct the selection process based on the priority parameter. The priority parameter not only determines the placement sequence but also may play a role in the cleaning up operation 440, which will be discussed below. It should be appreciated that other criteria may be used by the SRAF template selection module 320 to determine the placement sequence. Users may specify any sequences they desire.

In operation 430, the SRAF template application module 340 places the selected SRAF template in the layout design. First, the main features belonging to the specific type of main features for which the selected SRAF template is generated are identified by the module 340. The information used for identification may include various geometric parameters such as sizes, shapes and relationship with neighboring features. Then the SRAF template is placed based upon the locations and orientations of the identified main features and the SRAF template's specification. The operation 430 is similar to a conventional rule-based SRAF placement in that the selected SRAF applies only to those main features satisfying requirements of a “rule” and the placement is executed according to the parameters also specified in the “rule.” On the other hand, rather than placing one-dimension scattering bars adjacent to edges of a main feature, the operation 430 includes placing SRAF templates around the main feature since many SRAF templates have a two-dimensional structure such as those shown in FIG. 5 (some templates may be one dimensional structures as discussed above). Moreover, these SRAF templates may be derived by using model-based methods or through some optimization procedures which can work effectively with two dimensional main features such as contact features.

In operation 440, the clean-up module 360 applies the clean-up rules stored in the database 345 to solve conflicts caused by the placement of the selected SRAF template. As discussed above, conflicts can arise when MRC rules are violated or a placed SRAF will be printed. With various implementations of the invention, when an SRAF in the selected SRAF template violates spacing rules with a main feature, it may be removed automatically. When two or more SRAFs from different template placements violate MRC rules or cause SRAF printing, more complex clean-up rules may apply. For example, conflicts may be ignored if two SRAFs exactly overlap with each other. SRAFs with lower priority may be eliminated if they are in conflict with SRAFs with higher priority. If the conflict region defined by the conflicting SRAFs is small, a single SRAF may be placed at the center to replace the conflicting SRAFs. If the conflict region is large enough, the conflicting SRAFs may be removed and the conflict region may be filled with one or more SRAFs from the successive SRAF templates being placed. The above clean-up rules are just examples. Users can develop any clean-up rules suitable for their lithographic processes. Model-based SRAF placement approaches or optimization procedures may be employed for developing the clean-up rules so that the resulted SRAF pattern can retain their benefit in compensating for proximity effects as much as possible.

Model based analysis of multiple contact configurations shows the idea SRAFs tend to form by merging, splitting and/or moving rather than form OR/And'ing the conflicting SRAFs when two isolated main features are brought closer. The application of successive SRAF templates that can fill conflict regions may mimic this observation better than a conventional rule-based SRAF method. In operation 450, the output module 380 determines whether more SRAFs are needed after the selected SRAF template is placed and the corresponding clean-up process is completed. As discussed above, one simple criterion is whether there are more SRAF templates left in the SRAF set which have not been applied. The SRAF placement tool 300 may repeat the placement process until all SRAF templates in the set are used. Another criterion can also be used: whether there is an empty region near a main feature that can be filled with one or more SRAFs from an unused SRAF template. Users of the tool 300 can also supply other criteria. Once the output module 380 determines no more SRAFs are needed, the SRAF pattern formed by all the placed SRAFs is stored in the output database 385.

### Conclusion

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, various pattern matching methods may be employed by the SRAF template application module 340 to identify the main features for placing certain SRAF templates. Moreover, the methods according to various embodiments of the invention may be combined with a conventional ruled-based SRAF placement method. For example, an implementation of the invention may take an SRAF pattern constructed by a conventional rule-based SRAF approach as a reference layer, or vice versa.

What is claimed is:

1. A method of sub-resolution assist feature (SRAF) placement, comprising:
receiving a set of SRAF templates;
selecting an SRAF template from the set of SRAF templates;
applying the SRAF template to one or more main features identified in a layout design, the one or more main features being identified to belong to a type of main features for which the SRAF template is generated;
performing a clean-up process according to clean-up rules if applying the SRAF template cause a conflict;
repeating operations of selecting, applying and performing until a termination condition is met; and
storing generated SRAFs for the layout design.

2. The method recited in claim 1, wherein the set of SRAF templates are generated by using a model-based SRAF solution.

3. The method recited in claim 1, wherein the set of SRAF templates are generated by using an optimization procedure.

4. The method recited in claim 1, wherein selecting an SRAF template is based on a priority parameter.

5. The method recited in claim 1, wherein the one or more main features are one or more two-dimensional main features.

6. The method recited in claim 5, wherein the one or more two-dimensional main features are one or more contact features.

7. The method recited in claim 1, wherein the one or more main features are identified by using a pattern matching method.

8. The method recited in claim 1, wherein the clean-up rules include removing conflicting SRAFs if one or more eliminating conditions are met.

9. The method recited in claim 8, wherein one of the one or more eliminating conditions is related to a size of a conflict region formed by the conflicting SRAFs.

10. The method recited in claim 8, wherein one of the one or more eliminating conditions is related to a MRC (manufacturing rule check) violation.

11. The method recited in claim 1, wherein the clean-up rules include removing a low priority SRAF and keeping a high priority SRAF.

12. The method recited in claim 1, wherein the clean-up rules include replacing conflicting SRAFs with one or more SRAFs in a conflict region formed by the conflicting SRAFs.

13. The method recited in claim 1, wherein the termination condition is that all SRAF templates in the set of SRAF templates are selected.

14. A method of SRAF template generation, comprising:
selecting one or more main features;
generating SRAFs for the one or more main features by using a model-based method;
constructing one or more SRAF templates based on the SRAFs; and
storing the one or more SRAFs in a medium.

15. The method recited in claim 14, further comprising:
applying the SRAF templates to main features identified in a layout design.

16. A method of SRAF template generation, comprising:
selecting one or more main features;
generating one or more SRAF templates for the one or more main features;
modifying the one or more SRAF templates through an optimization procedure; and
storing the modified one or more SRAF templates in a medium.

17. The method recited in claim 16, wherein the optimization procedure includes optimizing a process variation metric:

18. A processor-readable medium storing processor-executable instructions for causing one or more processors to perform a method of SRAF placement, the method comprising:
receiving a set of SRAF templates;
selecting an SRAF template from the set of SRAF templates;
applying the SRAF template to one or more main features identified in a layout design, the one or more main features being identified to belong to a type of main features for which the SRAF template is generated;
performing a clean-up process according to clean-up rules if applying the SRAF template cause a conflict;
repeating operations of selecting, applying and performing until a termination condition is met; and
storing generated SRAFs for the layout design.

19. The processor-readable medium recited in claim 18, wherein the set of SRAF templates are generated by using a model-based SRAF solution.

20. The processor-readable medium recited in claim 18, wherein the set of SRAF templates are generated by using an optimization procedure.

21. The processor-readable medium recited in claim 18, wherein the one or more main features are one or more two-dimensional main features.

22. A system comprising one or more processors, the one or more processors programmed to perform a method of SRAF placement, the method comprising:
receiving a set of SRAF templates;
selecting an SRAF template from the set of SRAF templates;
applying the SRAF template to one or more main features identified in a layout design, the one or more main features being identified to belong to a type of main features for which the SRAF template is generated;
performing a clean-up process according to clean-up rules if applying the SRAF template cause a conflict;
repeating operations of selecting, applying and performing until a termination condition is met; and
storing generated SRAFs for the layout design.

23. The system recited in claim 22, wherein the set of SRAF templates are generated by using a model-based SRAF solution.

24. The system recited in claim 22, wherein the set of SRAF templates are generated by using an optimization procedure.

25. The system recited in claim 22, wherein the one or more main features are one or more two-dimensional main features.
